(19) United States
(12) Patent Application Publication
(10) Pub. No.: US 2018/0229386 A1
(43) Pub. Date: Aug. 16, 2018

(54) Handheld Cutting Devices and Methods

(71) Applicant: Spellbound Development Group, Inc., Newport Beach, CA (US)

(72) Inventors: Earl Votolato, Newport Beach, CA (US); Ryan Burkes, Huntington Beach, CA (US)

(21) Appl. No.: 15/877,833

(22) Filed: Jan. 23, 2018

Related U.S. Application Data
(60) Provisional application No. 62/459,154, filed on Feb. 15, 2017.

(51) Int. Cl. B26B 27/00; B25F 3/00; B25F 5/02

(52) U.S. Cl. CPC B26B 27/005; B26B 29/06; B25F 5/02; B25F 3/00

(57) ABSTRACT

The inventive subject matter provides apparatus, systems and methods for ergonomic handheld cutting tools. Some contemplated handheld cutting tools will include an articulating gripping portion, and allow for adjustability of a cutting depth. Additionally or alternatively, contemplated tools can be motored power and include one or more auxiliary power packs tethered to the handheld portion.

This application claims priority to U.S. provisional application Ser. No. 62/459154, filed Feb. 15, 2017.

### FIELD OF THE INVENTION

The field of the invention is handheld cutting devices, especially motor powered handheld cutting devices, and handheld cutting devices providing an adjustable cutting depth.

### BACKGROUND

The following description includes information that may be useful in understanding the present invention. It is not an admission that any of the information provided herein is prior art or relevant to the presently claimed invention, or that any publication specifically or implicitly referenced is prior art.

Regardless of how carefully inventory is handled, there remains a significant risk of inventory loss (shrinkage) when items are removed from corrugated cardboard boxes and other packaging items. Items that are packaged in heavy duty double and triple corrugated boxes (e.g., large appliances, electronic goods, pre-packaged bulk food product and raw materials) are especially prone to damage due to the pushing force required to cut through thick packaging, Furthermore, there is a higher risk of employees becoming injured from ergonomic issues.

Although some efforts have been made in an attempt to address these concerns, known efforts fail to provide optimally ergonomic hand-held cutting tools that significantly reduce the likelihood of shrinkage caused by human error.

Thus, there is still a need for improved handheld cutting devices and methods.

### SUMMARY OF THE INVENTION

The inventive subject matter provides apparatus, systems and methods of a handheld cutting tool comprising a gripping component that is movably coupled to a tool bit having an operating end. In some aspects, the gripping component is coupled to the tool bit via a pivot joint that allows for rotation of the gripping component relative to the tool bit, or a ball and socket joint that enables the gripping component to move in all or nearly all directions relative to the tool bit as the ball rotates in various directions relative to and within the socket.

The handheld cutting tool could be configured such that an operating end of the tool bit has an operating depth that is adjustable. For example, the tool bit could be configured to extend out of a housing component to various extents depending on a characteristic of the object to be cut, or an operation of a trigger or actuator that moves the tool bit between first and second different positions.

The tool bit could advantageous comprise at least one of an oscillating bit, a vibrating bit, a reciprocating bit and a rotating bit. The tool bits could be configured to perform different functions (e.g., cut, shape, drill, drive/ remove screws), and the motion of the tool bit could be drive by an electric motor powered by a suitable power source. In some preferred aspects, the tool bit could be removable and replaceable with respect to the tool bit holder such that the handheld power tool could be used to perform numerous functions at different times.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1E illustrate a handheld tool of the inventive subject matter.

FIG. 1F illustrates a cross-sectional view of a handheld tool.

FIGS. 2A-2D illustrate another handheld tool having a different gripping portion.

FIGS. 3A-3D illustrate a handheld tool having a joystick type gripping portion.

FIGS. 4A-4D illustrate a handheld tool having an open frame gripping portion.

FIGS. 5A-5B illustrate a handheld tool tethered to a power pack.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

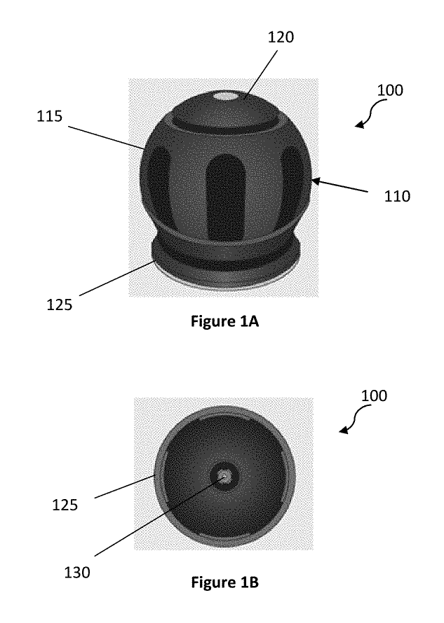

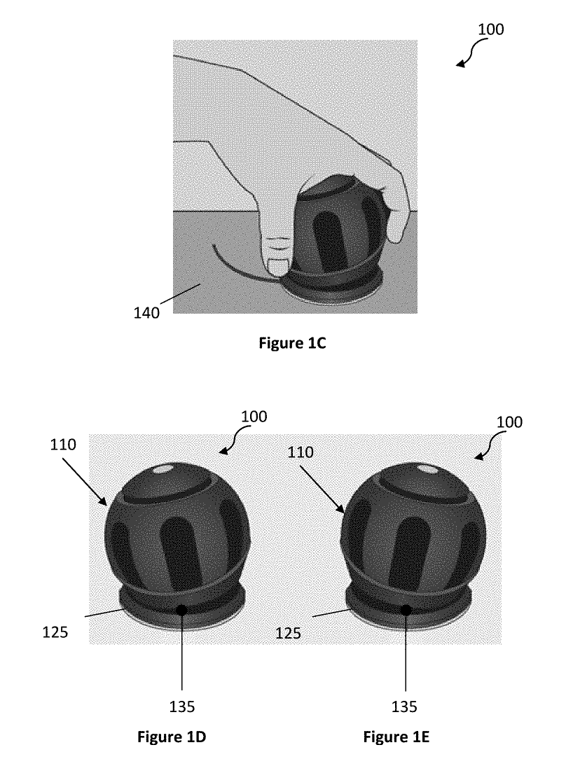

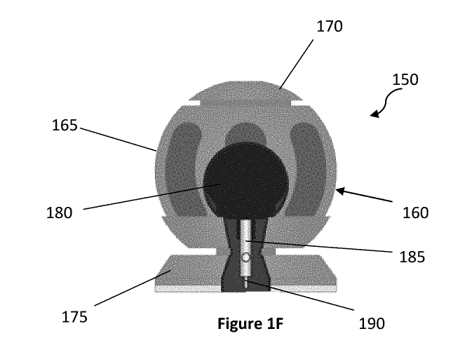

In FIGS. 1A-1E show a handheld ergonomic tool of the inventive subject matter including a manually controlled adjustment mechanism. Tool 100 comprises an articulating housing component 110 including a gripping portion 115 and a spring loaded actuating element 120. The articulating housing component 110 is movably coupled with a tool bit 130, and is fixedly or movably coupled with base 125. Here, base 125 includes an opening through which tool bit 130 could extend through. The base is configured to advantageously limit the amount of movement between the housing component 110 and the tool bit, and is configured to contact the cutting surface and provide a more controlled cut. The base could also help limit the cutting depth of the tool bit where the extent to which the cutting edge is exposed is limited by the base. However, it should be appreciated that the handheld cutting tool could function without the base, and embodiments not including a base are contemplated herein.

Housing component 110 is a substantially spherical in shape, and includes a gripping portion (e.g., upper portion) that is sized and dimensioned to fit in the palm of a user's hand, similarly to a baseball. The gripping portion could comprise a gripping material (e.g., silicone), or be shaped in a manner that prevents the housing component 110 from slipping out of the user's hands.

As shown in FIGS. 1C-1E, first component 110 could be coupled to base 125 such that first component 110 can pivot, rotate or otherwise move relative to base 125 at point 135. Actuating element 120 could comprise a push button that projects from a surface of the gripping portion 115, and is configured to be pressed down to cause tool bit 130 to at least one of temporarily extend through base 125, and be activated (e.g., to rotate, oscillate, vibrate, reciprocate). The actuating element 120 could advantageously be positioned such that the user's hand automatically presses down on the actuating element 120 when the user presses the tool 100 against a cutting surface. When the user removes the cutting tool from the cutting surface, the actuating element 120 is released and the tool bit's cutting edge is retracted.

Where a tool of the inventive subject matter provides for an adjustable cutting depth, it should be appreciated that the adjustment could be manual as set forth above, or automatic. An exemplary automatically controlled cutting depth system could include one or more sensors (e.g., ultrasonic pulse sensors, sonic ranging sensors, temperature sensors, image sensors, magnetic sensors, inductive sensor, photoelectric sensor) that are configured to monitor an environment, and automatically adjust a cutting depth based on sensor data to prevent or limit contact between the cutting edge and the packaged item.

In some contemplated embodiments, the sensors can monitor how close the cutting edge of the tool bit is from the contents of the package being cut, and at least one of provide a light, sound or other indication or warning, and partially retract the tool bit based on the sensor data.

Additionally or alternatively, the tool bit's cutting edge could be made from a material softer than the contents of the package, and thus not substantially damage the contents. For example, a tool bit used to open packaging containing metal or wooden objects could comprise a plastic or rubber tip that cuts through the packaging, but does not substantially damage the item contained within the packaging material.

Additionally or alternatively, a light, sound or other indication or warning could be provided when an object having a hardness above a threshold (e.g., a hardness of at least 10, at least 20, at least 30, at least 40, at least 50, at least 60, at least 70, or at least 80 on the Shore A durometer scale) is contacted by the tool bit. The tool bit cutting depth could manually be adjusted a user via a button, trigger or other setting adjustment component.

In FIG. 1F, a cross-sectional view of handheld tool 150 is provided to illustrate one contemplated embodiment in which tool bit 180 (having cutting edge 190) is coupled to first component 160 via tool bit holder 180. First component 160 includes a gripping portion 165, an actuating element 170 that composes the gripping portion 165, and a cavity sized and dimensioned to hold a ball-shaped or other tool bit holder 180 in a manner that allows tool bit holder to move up and down relative to base 175 in a controlled manner based on a manual actuation (e.g., pressing down) of actuating element 120.

The tool bit holder is preferably sized and dimensioned to receive and secure a non-operating end of the tool bit 180 in place. As used herein, the term “non-operating end” is used broadly to include an end of the tool bit that is not used as the cutting edge at the time the tool is used. Viewed from a different perspective, the non-operating end could comprise a cutting edge of a dual sided tool bit.

Additionally or alternatively, the coupling between the ball-shaped tool bit holder 180 and the first component cavity could allow for rotation, oscillation, vibration, reciprocation, circumduction, and other movements of the tool bit relative to first component 160. Contemplated tool bits include, among other things, a bladed tip, a drill bit, a paddle bit, a router bit, a dowel bit, saw blades, and blades, which can be made of any suitable material, including for example, a plastic, a metal, a ceramic, a steel, a cobalt, a diamond, a paper, and any combinations thereof.

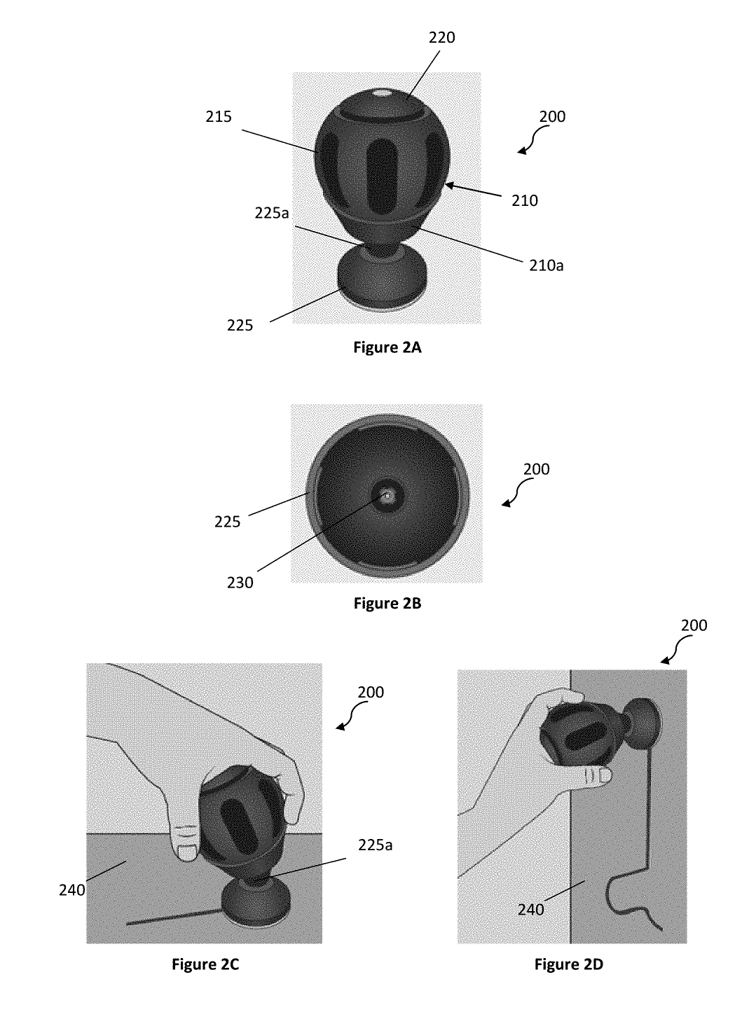

FIGS. 2A-2D illustrate a handheld power tool 200 of the inventive subject matter, which similarly includes a first component 210 including gripping portion 215 and actuating element 220. First component 210 is configured to house one, some or all of the tool's power and control circuitry, including for example a motor, an internal power supply (e.g., battery), a printed circuit board, a drive shaft, and a transmission. In other contemplated embodiments, some or all of the components (e.g., other than the tool bit and cutting depth adjusting mechanism) could be housed in one or more secondary packs that are coupled to the handheld portions of the power tool. Actuating element 220 could be a trigger and configured to activate a switch to turn the power tool on, completing the electric circuit and allowing energy to pass to the motor.

First component 210 is coupled to second component 210a, which includes a cavity sized and dimensioned to receive at least a portion of connector 225a to allow for movement of first component relative to base 225. Such an arrangement allows for additional room within first component 220 to house one, some or all of the electronic components of power tool 200, while maintaining its compact size. In some contemplated embodiments, connector 225a could comprise or be coupled with a tool bit holder to which tool bit 230 is secured.

Power tool 200 could advantageously be used to cut packaging and other objects (e.g., 240) without injury to the user, and without damaging items being removed from packaging 240. In some contemplated embodiments, an edge guide component can be provided that allows a user to maintain a straight and controlled cut. This feature makes it easy to cut off the flaps of a box, and to make a cut down the side of a box while maintaining a straight and controlled cut. One can also use the guides to control the angle of a cut so it may be positioned above the contents of a package. The guides are preferably retractable, and lockable in either retracted or operating positions. This allows the power tool to be used with differently contoured surfaces without the edge guides blocking a movement except where desired. The distance between the guides and the blade of the knife can be either fixed or adjustable. Some exemplary edge guide components are described in U.S. Pat. No. 7,082,688 to Votolato, which is incorporated by reference in its entirety.

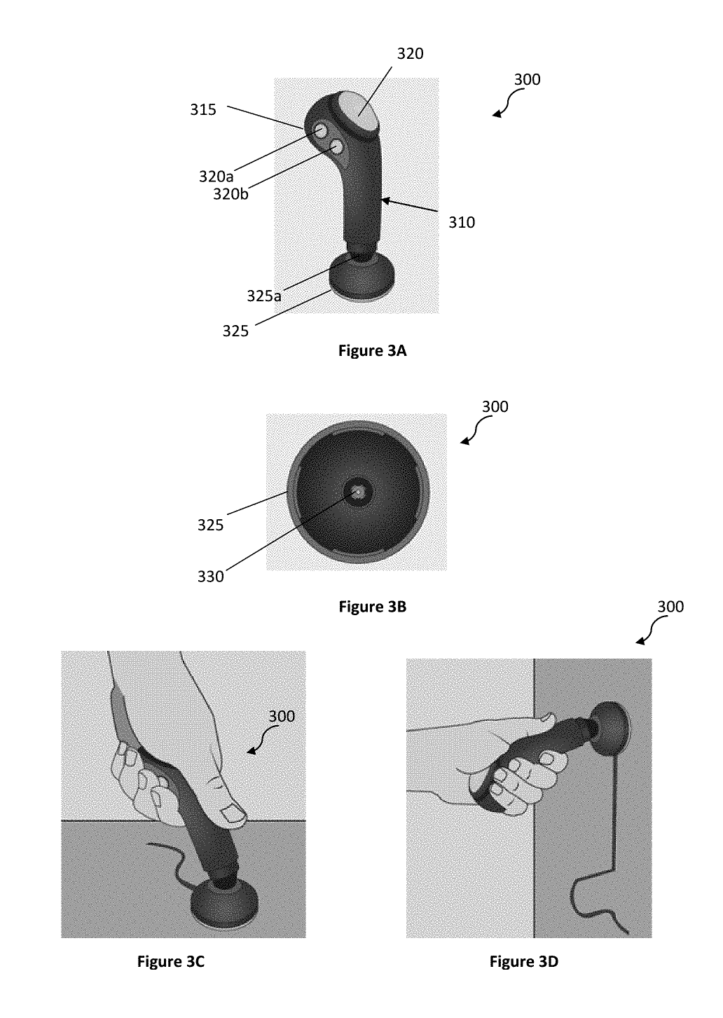

FIGS. 3A-3D illustrate yet another power tool 300, which includes a power element, one or more cutting depth adjustment elements, and one or more movement adjustment elements. Similarly to power tool 200, power tool 300 comprises a first housing component 300 that includes a gripping portion 315 and actuating element (here power element) 320. First component 310 is movably coupled with base 325 via a joint 325a. Base 325 includes an opening sized and dimensioned such that at least a portion of cutting tool 330 can extend through base 325 and onto a cutting surface.

Power tool 300 also includes a set of adjustment controls (e.g., adjustment controls 320a, 320b), which allow a user to adjust a cutting depth of the tool bit 330, modify the type or speed of a movement of the tool bit (e.g., from rotating to reciprocating), lock first component 310 in a desired position relative to base 325, release first component 310 from a locked position relative to base 325, lock tool bit 330 in a desired position relative to base 325, release tool bit 330 from a locked position relative to base 325, or provide any other desired adjustment for a desired cut.

It is also contemplated that power tools and non-motor drive tools of the inventive subject matter can comprise one or more movable or fixed auxiliary blades or tool components (e.g., screwdrivers, hooked knife, straight cutter, scraper) that could be used with or without a power source (other than the user himself). A tape splitter separate from the tool bit could also optionally be provided (e.g., a rounded and durable metal or plastic tip), which can cut through tape on packaging without causing the tool bit itself to become sticky, and without damaging the item contained within the box.

Additionally or alternatively, some contemplated power tools of the inventive subject matter could comprise or include an attachment for a vacuum and dust trapping component, a brush, a fan or other component(s) that prevents a build-up of dust within the power tool, the tool bit, or the tool bit holder.

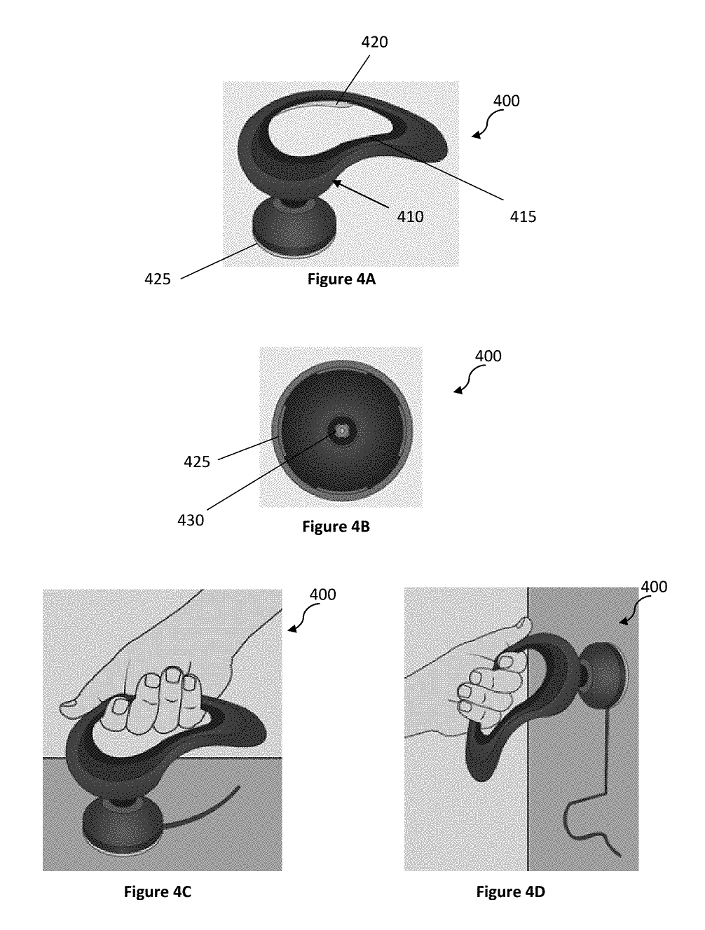

FIGS. 4A-4D illustrate yet another embodiment of a cutting tool of the inventive subject matter, which comprises a looped gripping portion or handle, and an actuating element positioned on an underside of the gripping portion. Cutting tool 400 includes a first component 410 including a gripping handle 415 and trigger 420. First component 410 is movably coupled to base 425 via a ball and socket or other connection. Tool bit 430 is secured to at least one of first component 410 and base 425, and is configured to temporarily expose a cutting end to cut a surface.

As described above, it is contemplated that some or all components that provide power to a tool of the inventive subject matter could be housed in a non-handheld portion of the tool, for example in one or more auxiliary components.

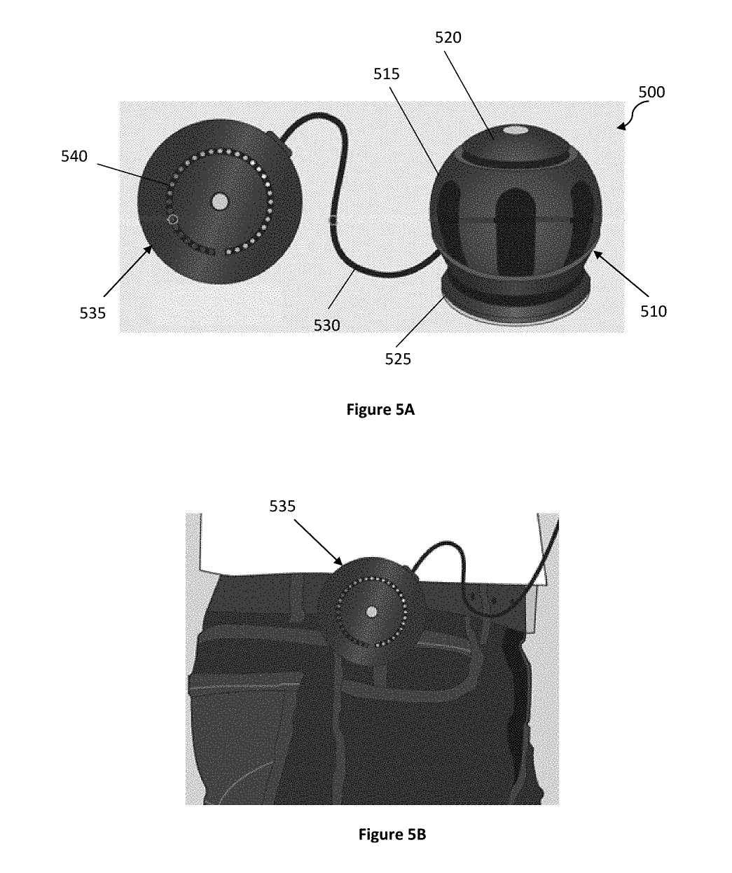

FIG. 5A illustrates a handheld power tool 500 that is tethered to power pack 535. The handheld portion of power tool 500 includes a first housing 510 including a gripping portion 515 and actuator element 520. First component 510 is coupled with base 525 in a manner that limits the amount of movement of first component 510 relative to base 525. Power tool 500 is tethered to power pack 535, and cord 530 could be retractable to be positioned within first component 510, base 525 or power pack 535. Power pack 535 includes a power level indicator 540, and comprises at least one of a replaceable and re-chargeable battery. The power level indication could be provided in any suitable form, including as a light via LED or other bulbs, a sound via a speaker, a temperature change, a flashing or change in color of a light, or a vibration.

It should be appreciated that tools of the inventive subject matter could include a motor configured to be powered by direct current sources (e.g., batteries), alternating current sources (e.g., power grids, inverters, generators), solar energy sources, or any combinations thereof

In some contemplated embodiments, a power pack could be coupled to the power tool via a cord. Components of the power tool such as the power source, motor, vacuum, drive parts, transmission, and actuators could be housed within one or more housings of the power tool. For example, some or all components could be housed in the first component or base of the handheld portion of tool 500. Additionally or alternatively, some or all of the components could be housed in a separate auxiliary base unit that is coupled to the handheld components of the power tool via a cord. For example, the power source (battery or corded AC), motor, vacuum and drive parts could all be located in a tethered base unit that is either worn or placed on a surface near the user using the tool. The base unit or an additional tethered unit could also be sized and dimensioned to house various tool bits, a motor, a drive component, a circuit board, a controller, a power indicator (bulbs, speakers), and any other commercially suitable components. The hand-held device could simply house the tool bit and the depth adjustment elements.

Such a power tool could be operated similarly to a dentist's drill or tattoo gun, where the dentist or artist holds a housing including the drill or needle, and the drive and power mechanisms are in a base unit tethered to the housing. Such a unit would be advantageous since the handheld portion would be lighter in weight than other traditional power tools, and thus easier to maneuver. As shown in FIG. 5B, power pack 535 can conveniently be coupled to a user's clothing or belt via a clip or other fastening connection such that the power tool is not lost. It is also contemplated that power pack 535 could be coupled to a power pack via a tethered lanyard. The lightweight and handheld portion of tool 500 can be coupled to power pack via a self-retracting or retractable tether such that the risk of misplacing tool 500 is minimized without increasing the risks associated with cords.

Therefore, several embodiments of the inventive handheld tool have been described above. It should be apparent, however, to those skilled in the art that many more modifications besides those already described are possible without departing from the inventive concepts herein. The inventive subject matter, therefore, is not to be restricted except in the spirit of the disclosure. One skilled in the art will recognize many methods and materials similar or equivalent to those described herein, which could be used in the practice of the present invention. Indeed, the present invention is in no way limited to the methods and materials described.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range, including their endpoints. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A hand-held tool, comprising:
a first component including gripping portion; and
wherein the first component is movably coupled with a tool bit.

2. The tool of claim 1, further comprising a motor.

3. The tool of claim 1, wherein the tool bit is at least one of an oscillating bit, a vibrating bit, a reciprocating bit, and a rotating bit.

4. The tool of claim 1, wherein the tool bit comprises a cutting edge.

6. The tool of claim 1, wherein at least a portion of an operative end of the tool bit is configured to extend beyond an outer wall of the first component, and further comprising a trigger configured to cause the operative end of the tool bit to move from a first position to a second position different from the first position.

7. The tool of claim 1, wherein the tool is battery powered.

8. The tool of claim 1, wherein the tool bit is a cutting tool bit having an adjustable cutting depth.

9. The tool of claim 8, wherein the adjustable cutting depth is adjusted based on a sensor.

10. The tool of claim 1, further comprising at least one of a vacuum suction component, and a dust collection component.

11. The tool of claim 1, further comprising a tape splitter component.

12. The tool of claim 1, further comprising a utility knife.

13. The tool of claim 1, further comprising an edge guide component that allows for maintaining a controlled cut.

14. The tool of claim 1, further comprising a power pack and circuit board coupled to a housing via a cord, and wherein the power pack includes at least one of a magnetic fastener, a clip, a buckle, a velcro, a retaining ring, and a strap configured to releasably fasten the power pack to at least one of an item worn by a user and an object adjacent a cutting surface.

15. The tool of claim 1, wherein the first component is movably coupled with the tool bit via a ball and socket joint, and wherein the first housing has a 360 degree direction of movement relative to the second housing, and is configured to move along the x, y and z axes.

16. A hand-held tool, comprising:
a first housing portion movably coupled with a second housing portion such that the first housing can move 360 degrees relative to the second housing;
wherein the first housing portion comprises a gripping portion;
wherein a cutter bit is positioned through at least a portion of an opening of the second housing;
wherein at least one of the first and second housing portions comprises a motor; and
wherein at least a portion of an operative end of the tool bit is configured to adjustably extend through the opening beyond an outer wall of the second housing to at least first and second different extents.
